(19) United States
(12) Patent Application Publication
(10) Pub. No.: US 2025/0124148 A1
(43) Pub. Date: Apr. 17, 2025

(54) SECURE CASTING FOR CUSTOMIZED HOME ENTERTAINMENT AND INFORMATION

(71) Applicant: Robert B Hanson, II, Mobile, AL (US)

(72) Inventor: Robert B Hanson, II, Mobile, AL (US)

(21) Appl. No.: 18/919,389

(22) Filed: Oct. 17, 2024

Related U.S. Application Data
(60) Provisional application No. 63/544,593, filed on Oct. 17, 2023.

(51) Int. Cl. G06F 21/60; G06F 3/14; H04L 12/28

(52) U.S. Cl. CPC G06F 21/606; G06F 3/1423; H04L 12/2816

(57) ABSTRACT

A system and method for the secure presentation of multi-window displays on one or more screens within an environment is disclosed. The invention enables the creation and management of primary and secondary data windows on a single display device or across multiple display devices. Through a multi-layer authentication process, including pattern recognition and permission-level verification, authenticated users may transmit computer-readable signals for augmenting the casting of a primary media window with one or more contextually aware secondary windows. These secondary windows are capable of securely recognizing and responding to the content and context of other displayed windows, enabling interaction among windows to customize the user's multi-window display experience. This system provides a secure and personalized means of presenting a plurality of information sets within the environment.

### FIELD OF THE DISCLOSURE

The present disclosure is generally related to smart home display systems and, more specifically, to a secure method and system for managing multi-window displays across one or more screen interfaces within an environment.

### BACKGROUND

In the field of smart home displays, conventional systems are generally limited to singular or isolated functionalities, typically facilitating the display of only one type of media content or application at a given time. This constraint leads to suboptimal user engagement and operational efficiency. Furthermore, the prevailing systems suffer from limited context awareness. Specifically, these systems do not possess the capability to dynamically adapt or adjust the content presented in one window based on the context or information available in other active windows or displays within the same environment.

Another noteworthy deficiency in current smart home display technologies pertains to security. Existing multi-window display solutions generally lack secure context-aware protocols that can securely manage the interaction between multiple windows. This results in potential security vulnerabilities and risks of unauthorized data access or interference. Moreover, the degree of user customization and personalization in current systems is markedly restricted. Users are typically unable to customize the arrangement and interaction of multiple windows across one or more displays, thus limiting the system's adaptability to individual user requirements.

Additionally, existing smart home display systems are inadequate in managing and casting multiple types of content across multiple screens within a home environment. There is an absence of mechanisms that allow for the synchronized display of diverse media types or applications across various displays in a secure manner. User interaction with existing systems is also inefficient. Conventionally, users are required to manually toggle between different windows or screens to access different types of content or applications, resulting in a cumbersome and less-intuitive user experience.

Lastly, the scalability of existing smart home display systems poses a significant constraint. These systems are not inherently designed to accommodate the seamless integration of additional displays or new types of media content or applications, thereby limiting their adaptability to evolving user needs and technological advancements. Thus, there exists a need for a smart home display system that overcomes the aforementioned limitations, offering secure multi-window functionality, enhanced context awareness, increased customization options, and robust scalability features.

Accordingly, there is a need in the art for a system and method for securely managing a smart home via a display that securely connects to a user's computing device to allow for the secure and efficient management of said smart home.

### SUMMARY

The invention serves to significantly enhance user interaction with smart home displays by introducing secure multi-window functionalities on one or more screens. Users can cast multiple types of media or information onto a singular display, each contained in its own window.

Furthermore, these windows are securely aware of the content and context of each other, enabling meaningful interaction between them to create a tailored user experience. For instance, a user could simultaneously view a security camera feed, control smart home devices, and watch streaming media, all while the windows are context-aware to prevent content clashes or security issues. This allows for a more personalized and efficient interaction with the smart home environment, elevating the user's ability to multitask and control various smart home functionalities through a single, unified interface.

### DESCRIPTIONS OF THE DRAWINGS

FIG. 1 illustrates a diagram of an example environment in which a system and method may be implemented consistent with the principles of the present disclosure.

FIG. 2 illustrates a diagram of an example environment in which in which a system and method may be implemented consistent with the principles of the present disclosure.

FIG. 3 illustrates a diagram of an example environment in which a system and method may be implemented consistent with the principles of the present disclosure.

FIG. 4 illustrates a diagram of a system embodying features consistent with the principles of the present disclosure.

FIG. 5 illustrates a system for securely casting customized content in a smart home environment consistent with the principles of the present disclosure.

FIG. 6 illustrates a secure casting network consistent with the principles of the present disclosure.

FIG. 7 illustrates a method for controlling a display consistent with the principles of the present disclosure.

FIG. 8 illustrates a method for utilizing a user interface consistent with the principles of the present disclosure.

FIG. 9 illustrates a method for preventing unauthorized system access consistent with the principles of the present disclosure.

FIG. 10 illustrates a context awareness engine consistent with the principles of the present disclosure.

FIG. 11 illustrates a multi-window manager consistent with the principles of the present disclosure.

FIG. 12 illustrates a method for media casting consistent with the principles of the present disclosure.

FIG. 13 illustrates a method for synchronizing control consistent with the principles of the present disclosure.

FIG. 14 illustrates a diagram of the manner in which individual access to data may be granted or limited based on user or administrator roles consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of managing security within an environment.

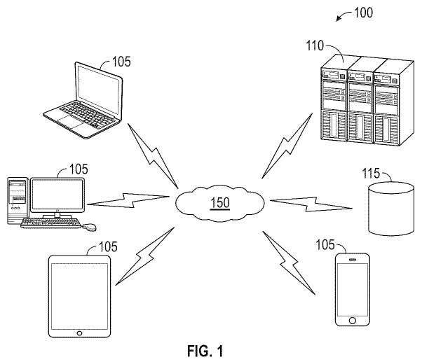

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

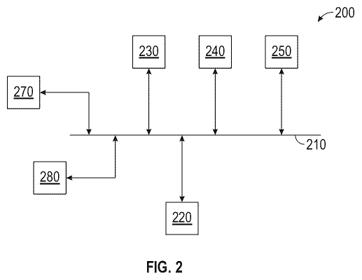

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200. Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, microphone, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, smart watches, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210.

Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

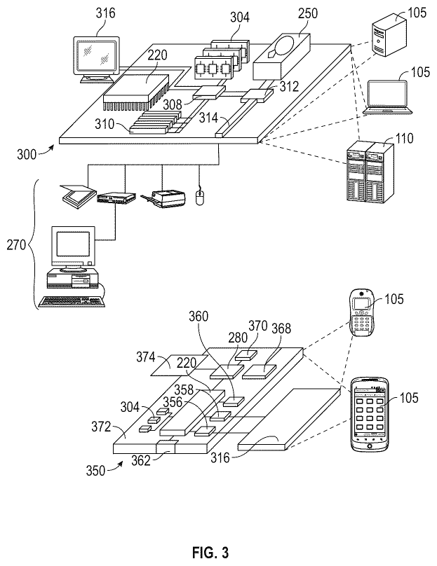

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411 applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation- and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power such as electricity. In a preferred embodiment, the primary power source of the system is a stationary power source, such as a standard wall outlet. In one preferred embodiment, the system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the power supply is not connected to a stationary power outlet or if the stationary power outlet ceases to provide power to the computing entity 200. In this way, the system 400 may receive power even in conditions in which a home may lose power, allowing the system to securely manage a home even when traditional sources of power are unavailable.

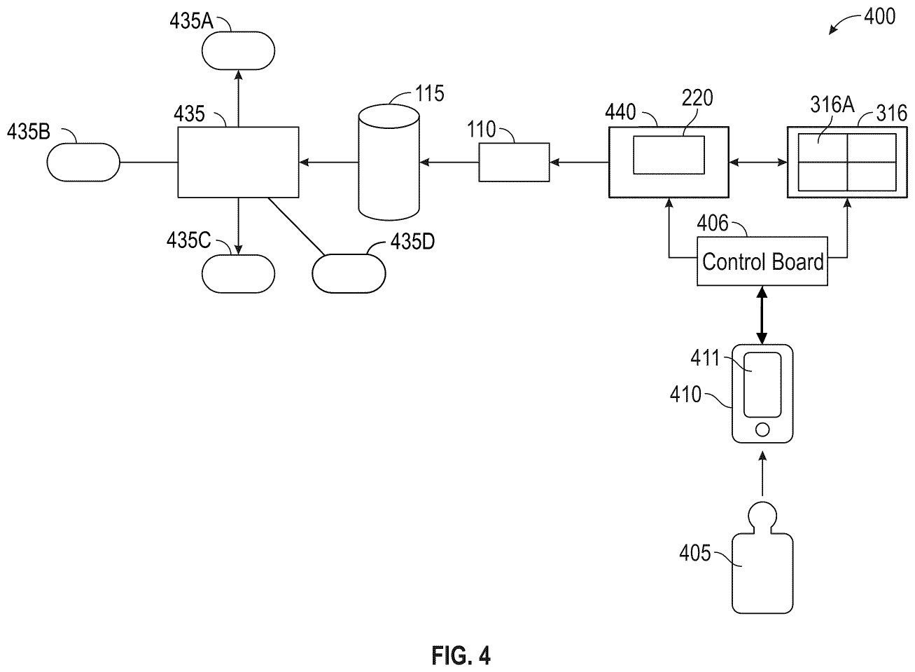

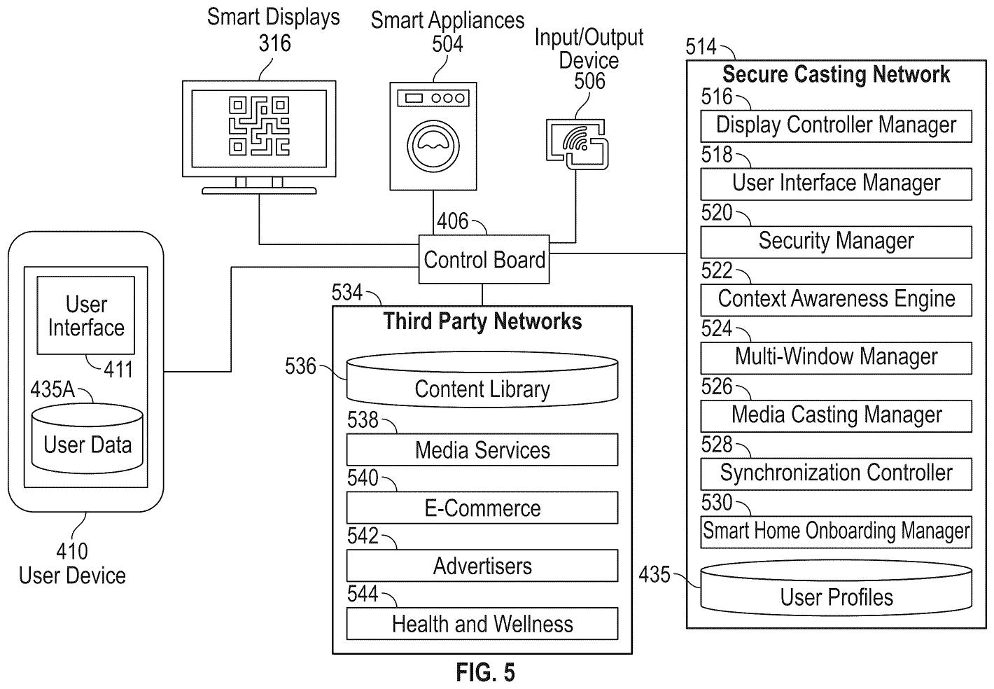

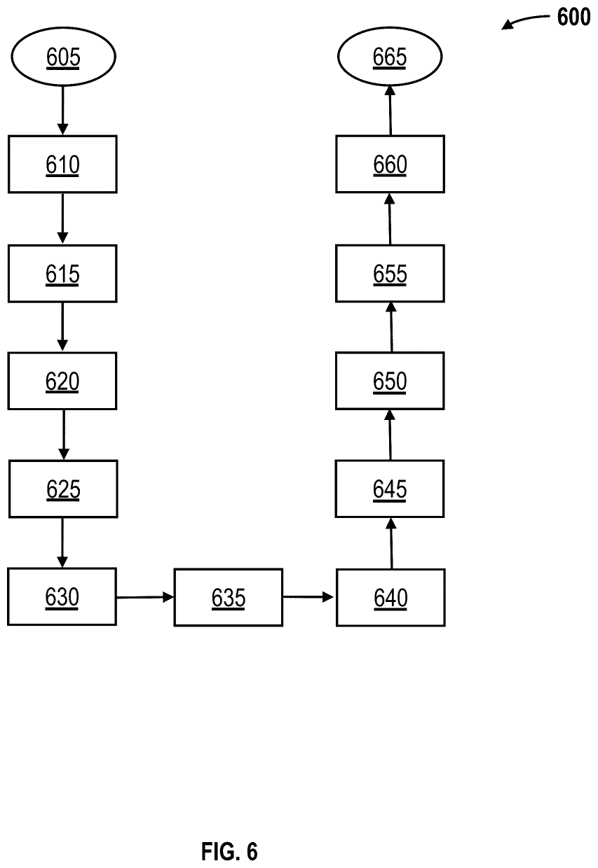

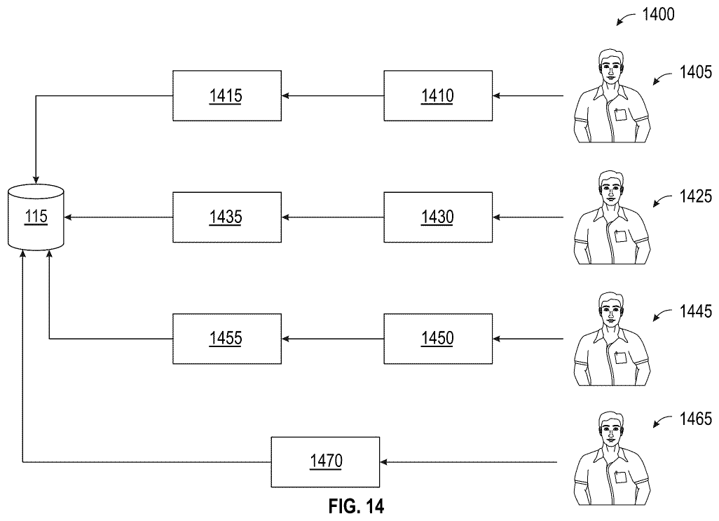

FIGS. 4-14 illustrate embodiments of a system 400 and methods 600, 700, 800, 900, 1000, 1100, 1200, 1300 for securely managing an environment comprising one or more displays 316 or appliances 504, including securely managing multiple screens of a display having a plurality of content sources. FIG. 4 illustrates a preferred embodiment of the system 400 having a computing device 410 and control board 406 in fluid communication with one another, wherein said control board 406 is configured to hijack one or more channels of a display 316 and present a display user interface 316A that may be controlled via the computing device 410. FIG. 5 illustrates how the control board 406 functions as a centralized controller for various devices including, but not limited to, lighting systems, audio devices, security systems, and home automation managers. FIGS. 6-13 illustrate methods that may be used to carry out the various functions of the system. It is understood that the various method steps associated with the methods 600, 700, 800, 900, 1000, 1100, 1200, 1300 of the present disclosure may be carried out as operations by the system 400 illustrated in FIGS. 6-13. FIG. 14 illustrates permission levels 1400 that may be utilized by the present system 400 for controlling access to user content 1415, 1435, 1455 such as user data 435A, image data 435B, application data 435C, and/or appliance data 435D, media services 536A, e-commerce 536B, advertisements 536C, and Health and Wellness Services 536D.

FIG. 4 illustrates a preferred embodiment of a system 400 for managing multi-window displays across one or more screen interfaces within an environment. In a preferred embodiment, a user 405 operates the user interface 411 on their computing device 410 in order to send computer signals to the control board 406, wherein said signals control the display user interface of the control board. The control board 406 receives said signals, organizes them, and then using its secure casting network 514 sends commands in the form of computer signals to a display 316 with any number of display windows 316a. The control board 406 further sends signals to relay 440 comprising at least one processor 220, which engages a server 110 in order to access a database 115. The database 115 comprises user profiles 435, which comprise user data 435A, image data 435B, application data 435C, and/or appliance data 435D.

In a preferred embodiment, a control board 409 is configured to receive user data 430A, image data 430B, application data 430C, and/or appliance data 430D from a computing entity 200 and/or one or more home appliances 407. The control board 409 may then present said user data 430A, image data 430B, application data 430C, and/or appliance data 430D via the display 316 in the display user interface 316A. In another preferred embodiment, the display may be configured to receive user data 430A, image data 430B, application data 430C, and/or appliance data 430D via a server and/or database when selected by a user via the user interface of the computing device and/or the display user interface of the display. In a preferred embodiment, the user data 430A, image data 430B, application data 430C, and/or appliance data 430D is streamed/mirrored/transmitted from the computing entity 200, server, and/or database to the control board 409, wherein the control board 409 inserts said streamed/mirrored/transmitted user data 430A, image data 430B, application data 430C, and/or appliance data 430D into the display user interface 316A. In a preferred embodiment, image data is streamed/mirrored from the computing entity 200, server, and/or database to the control board 409. Alternatively, the control board 409 may manipulate the user data 430A, image data 430B, application data 430C, and/or appliance data 430D and/or display windows 417 of the display user interface 316A based on commands received from an input device.

In a preferred embodiment, the control board 406 is configured to seamlessly integrate with existing display systems, enabling the secure management and presentation of multi-window displays. The control board 406 may hijack a display and its channels, allowing for the dynamic presentation of a customized display user interface. Upon initialization, the control board 406 establishes a secure connection with the target display, utilizing advanced communication protocols to ensure data integrity and security. This connection allows the control board 406 to take control of the display's output channels, effectively overriding any existing content to present the desired user interface. In another preferred embodiment, the control board 406 is equipped with advanced processing capabilities, allowing it to render a customized user interface directly on the display. This interface can support multiple windows, enabling users to interact with various applications and media content simultaneously. Furthermore, the control board 406 can manage multiple input channels, directing different types of content to specific windows on the display, which ensures that users can access and interact with diverse media types, such as streaming video, smart home controls, and security feeds, all within a unified interface.

In a preferred embodiment, the hijacking process involves the control board 406 sending specific computer-readable signals to the display, which are interpreted as commands to switch from the current input source to the control board's output. Once control is established, the control board 406 can render a multi-window interface on the display, allowing users to interact with various applications and media content simultaneously. The interface is customizable, enabling users to adjust window sizes, positions, and content according to their preferences. Additionally, the control board 406 can manage multiple channels within the display, directing different types of content to specific windows. This capability ensures that users can view and interact with diverse media types, such as streaming video, smart home controls, and security feeds, all within a unified interface.

In another preferred embodiment, the control board 406 may be configured to hijack the display via hardware, involving a direct physical connection to the display's input channels and allowing the control board 406 to assume control over the display's output. This process is designed to ensure seamless integration and secure management of multi-window displays. In one preferred embodiment, the control board 406 is connected to the display through a dedicated interface, such as HDMI, DisplayPort, or a similar connection. In another preferred embodiment, the control board 406 is connected to the circuit board of the display, bypassing any onboard control board 406 of the display. This physical link enables the control board 406 to intercept and override the existing input signals, effectively taking control of the display's output. Once connected, the control board 406 sends specific hardware-level commands to the display, instructing it to switch from its current input source to the control board's output.

In one preferred embodiment, the display user interface 316A may comprise a control window, which may provide a user 405 with options to control the layout of the display user interface 316A. For instance, a user 405 may choose a layout that separates the display user interface 316A into multiple windows arranged in a particular way. In some embodiments, the control window may allow a user to alter the size and orientation of a display window of the display user interface. Alternatively, an input/output device having a plurality of layouts thereon may be used to manipulate the layout of the display user interface 316A. The input/output device may be connected to the system 400 via a wired or wireless connection. In a preferred embodiment, the input/output device transmits a computer readable signal containing instructions to the control board 409, which the control board 409 uses to manipulate data presented via the display user interface 316A.

The control board 409 preferably comprises at least one circuit and microchip. In another preferred embodiment, the control board 409 may further comprise a wireless communication interface, which may allow the control board 409 to receive instructions from an input device controlled by a user 405. In a preferred embodiment, the control board 409 may control the plurality of display windows 417 of the display user interface 316A. The microchip of the control board 409 comprises a microprocessor and memory. In another preferred embodiment, the microchip may further comprise a wireless communication interface in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive the various data of the system from a server 110 and/or database 115 via the wireless communication interface.

FIG. 5 illustrates a system for securely casting customized content in an environment comprising at least one display 316 or appliance 504, wherein an appliance 504 is an appliance comprising at least one sensor and a display 316 is a display capable of interfacing directly with the control board 406. The control board 406 is operably connected to a display 316 in a way such that said display is connected into the overall system. The control board 406 is capable of rendering primary and secondary data windows on a single device or across multiple interconnected devices. Upon successful multi-layer authentication involving pattern recognition and/or permission-level verification, authenticated users may send computer-readable signals to generate a primary media window and optionally one or more contextually aware secondary windows within a display. These secondary windows securely interact with the primary media window and other secondary windows, recognizing and responding to their content and context, thereby enabling a customized multi-window display experience.

In a preferred embodiment, appliances 504, such as a smart oven, may be operatively controlled through the disclosed system's architecture for secure multi-window presentation. The system facilitates a hierarchy of primary and secondary display windows accessible on different devices. For instance, a wall-mounted display panel could serve as the primary screen displaying various types of content, while a mobile app functions as a secondary screen offering a user interface 411 for home automation controls. In another preferred embodiment, users authenticated via multi-layer authentication processes may employ the secondary screen to manipulate settings corresponding to the primary screen, such as temperature, lighting, and media controls, without the need to physically access the primary display. In yet another preferred embodiment, the system permits the alignment of specific display window content with particular appliances 504. For instance, a primary display window may exhibit a recipe, and through computer-readable signals, instruct the smart oven to adjust its time and temperature settings accordingly. Such a primary display window may itself comprise multiple secondary windows, presenting content like video preparation methods for the recipe, or the user's real-time health data. Thus, appliances 504 can be securely and contextually managed, augmenting the multi-window display experience while enabling centralized coordination within the environment connecting said appliances and controls.

In a preferred embodiment, the control board 406 interfaces with both primary and secondary display windows across single or multiple devices. The control board 406 serves as the central hardware component for the system. The adjustment and control of multiple devices or displays is preferably performed by the control board's control of the managers of the secure casting network 514. Through the system's multi-layer authentication process, which may comprise pattern recognition and permission-level verification, authenticated users may generate and transmit computer-readable signals to the control board 406. These signals facilitate the secure and context-aware adjustment and control of smart home devices in real-time. For instance, the user interface of a mobile device operably connected to the control board may provide an interface for lighting controls, enabling the user to adjust room illumination levels in synchrony with the content displayed on a primary window. Therefore, system integration via the control board 406 allows authenticated users to securely manage and customize various smart home functionalities through the system's multi-window display architecture. In a preferred embodiment, the control board 406 is capable of directly interfacing with any given display 402, taking control of said display's outputs to direct the function of the environment comprising one or more displays 316 or appliances 504.

As previously mentioned, the system may comprise an input/output device 506. In a preferred embodiment, the input/output device 506 is configured to provide the user 405 with direct control of the control board and the connected displays and appliances without reliance upon the computing device 410. Accordingly, the input/output device 506 is preferably operably connected to the control board 406. In one preferred embodiment, the input/output device 506 comprises a screen, user interface 411, and processor by which the control board 406 may be accessed. In another preferred embodiment, the input/output device 506 comprises a microphone and speaker with voice recognition capabilities.

The computing device 410 encompasses a variety of computing platforms, including but not limited to, smartphones, tablets, computers, smartwatches, augmented reality/virtual reality (AR/VR) glasses, and other wearable devices. Serving as a versatile interface, the computing device 410 facilitates user interaction with the disclosed system designed for secure multi-window displays in an environment comprising one or more displays 316 or appliances 504. In a preferred embodiment, the computing device 410 employs a multi-layer authentication process that combines pattern recognition algorithms with permission-level verification protocols to ensure secure access. Upon successful authentication, the computing device 410 is enabled to transmit computer-readable signals to the system, initiating the casting of primary and secondary data windows across one or multiple display devices connected to the system's control board 406. In yet another preferred embodiment, computing device 410 also supports context-aware augmentation and secure interaction among the cast data windows. This functionality enables users to manipulate the content and context between windows across different types of displays, including traditional screens and wearable devices. For instance, a user may use a smartwatch to cast a primary window that displays real-time health metrics on a wall-mounted display, while at the same time, managing a secondary window on AR glasses that shows contextually relevant fitness tips or controls.

Though some embodiments may mention a single computing device 410 of a user 405, one with skill in the art will recognize that multiple computing devices 410 of multiple users may be used without departing from the inventive subject matter described herein. Additionally, though some embodiments may refer to a single display, one with skill in the art will recognize that multiple displays may be linked together in a way that creates a “single” display that may be used in a manner not departing from the inventive subject matter described herein. For instance, four OLED televisions may be linked together in way that creates a multi-display that the system may use as a “single” display. Additionally, one with skill in the art will recognize that a plurality of displays may be controlled by a single control board 406, and the single control board 406 may manage the plurality of display windows 316A about the display user interfaces of the plurality of displays. In yet another preferred embodiment, two or more control boards 406 of two or more displays may be operably connected to one another and manage the plurality of display windows 316A about the display user interfaces of the plurality of displays in collaboration with one another. Accordingly, one with skill in the art will recognize that displays may be used in combination with one or more control boards 406 and one or more computing devices in a number of ways without departing from the inventive subject matter described herein.

As mentioned previously, the system 400 may comprise a user interface 411. A user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, upon successful completion of a multi-layer authentication process comprising pattern recognition, such as directing a camera component of the computing device 410 at a QR code displayed on displays 316 and permission-level verification, the user interface 411 facilitates the transmission of computer-readable signals to the system. These signals control the casting of primary and secondary data windows (display windows of the display user interface 316A) either on a single display device or across multiple display devices within the environment comprising one or more displays 316. The user interface 411 is engineered to ensure that secondary windows are securely context-aware, enabling them to recognize and respond to the content and context of other active windows in the system. This inter-window interaction capability allows authenticated users to customize their multi-window display experience while maintaining data security.

User data 435A of the system preferably comprises various sets of information required for the secure presentation of multi-window displays within the environment comprising one or more displays 316 or appliances 504. This data is instrumental in the multi-layer authentication process, contributing to pattern recognition and permission-level verification components. Once authenticated, user data 435A can be invoked to generate computer-readable signals that instruct the system in creating and managing primary and secondary data windows. Specifically, user data 435A may contain contextual and content-specific preferences that influence the behavior of secondary windows in securely recognizing and responding to the active windows within the system.

The secure casting network 514 functions as the communication backbone for the secure presentation of multi-window displays within the environment comprising one or more displays 316 or appliances 504. It enables the transmission of computer-readable signals between the various elements of the system, such as computing devices 410, displays 316, and the input/output device 506 while ensuring secure, authenticated access. This network layer incorporates a multi-layer authentication process, including pattern recognition and permission-level verification, to validate users before they can interact with the system.

The secure casting network 514 coordinates a variety of media and infotainment content streams in an environment comprising one or more displays 316 or appliances 504, designed to facilitate a multi-window interactive experience across various application scenarios. In a preferred embodiment, while enhancing a dual-screen movie-watching experience, simplifying home shopping, or enabling centralized smart home management, secure casting network 514 ensures a seamless and secure flow of data between primary and secondary screens or windows. In another preferred embodiment, the secure casting network 514 is designed to integrate various managers for the effective coordination of displays and appliances comprising at least one sensor. Such managers may comprise the display controller manager 516, user interface manager 518, security manager 520, context awareness engine 522, multi-window manager 524, media casting manager 526, synchronization controller 528, and smart home onboarding manager 530. These managers are activated in a sequence of steps to authenticate users, synchronize content, and offer context-aware interactivity, and each step may play a role in optimizing the user experience while maintaining a focus on security and data integrity.

The display controller manager 516, integrated within the secure casting network 514, serves as a centralized orchestrator for managing the creation, manipulation, and interaction of primary and secondary data windows across one or more display devices within the environment comprising one or more displays 316 or appliances 504. The display controller manager 516 interacts with authenticated user signals, transmitted through a multi-layer authentication process, to facilitate the casting of primary media windows and the augmentation thereof with one or more contextually aware secondary windows. The display controller manager 516 further interprets computer-readable signals from various system components, such as computing devices 410 and input/output devices 506, to securely synchronize and manage window content and context. In a preferred embodiment, the display controller manager may also enable interoperability with third-party networks 134, such as media services 536A, e-commerce platforms, advertisers 536C, and health and wellness services 536D.

The user interface manager 518, part of the secure casting network 514, provides versatile interaction capabilities to authenticated users within the environment comprising one or more displays 316 or appliances 504. The user interface manager 518 functions to facilitate real-time engagement with primary and secondary data windows displayed on one or more screens. Leveraging multi-layer authentication processes, the user interface manager 518 enables unique features such as a dual-screen toolbar for information capture. In a preferred embodiment, when a primary screen presents data such as a QR code, the user interface manager 518 allows the activation of a toolbar on the secondary screen, thereby enabling the capture of the QR code from the primary screen without requiring an external capturing device. Said toolbar may feature interactive elements, such as crosshairs, to facilitate selective capturing. In another preferred embodiment, the user interface manager offers functionality for image-based searches initiated from the secondary screen. This could, for instance, allow a user to capture a portion of a displayed movie scene on the primary screen and, using the toolbar, perform an image search in a separate contextually aware window. This enhances the user's capacity to securely interact with and capture information across multiple windows, enriching the overall multi-window display experience.

The security manager 520, incorporated within the secure casting network 514, serves as a robust safeguarding mechanism to ensure the secure management and display of multi-window content in an environment comprising one or more displays 316 or appliances 504. In a preferred embodiment, the security manager 520 provides a multi-layer authentication process that encompasses pattern recognition and permission-level verification. Once a user is authenticated, the security manager 520 validates the transmission of computer-readable signals intended to create or manipulate primary and secondary data windows. These windows, once rendered, are capable of recognizing and responding to the content and context of other displayed windows in a secure manner. Whether facilitating secure transactions in a home shopping experience, enhancing interactive features during movie-watching, or enabling centralized management of displays 316 and appliances 504, the security manager 520 aims to provide a seamless yet secure user experience.

The context awareness engine 522, integrated within the secure casting network 514, is preferably responsible for augmenting the primary media window with one or more contextually aware secondary windows in an environment comprising one or more displays 316 or appliances 504. Upon successful multi-layer authentication, the context awareness engine 522 receives computer-readable signals from authenticated users for dynamically generating and managing secondary data windows. These secondary windows are tailored to recognize and respond to the content and context displayed in the primary and other secondary windows. For instance, in a dual-screen setup for movie watching, the context awareness engine 522 synchronizes and presents additional information on the secondary screen that is contextually relevant to the content being displayed on the primary screen. Similarly, the engine facilitates instantaneous product look-up on the secondary screen when a user shopping online interacts with a product displayed on the primary screen. The engine also enables functionalities such as information capture, as illustrated by QR code capturing features, and integrated control over smart home systems, thereby enhancing the user's interactive experience across multiple data windows.

The multi-window manager 524, part of the secure casting network 514, preferably oversees the organization and interaction of primary and secondary data windows across single or multiple display devices in an environment comprising one or more displays 316 or appliances 504. Upon successful completion of a multi-layer authentication process, the multi-window manager is configured to receive computer-readable signals from authenticated users and coordinates the creation, placement, and management of these data windows. The multi-window manager is preferably designed to work in tandem with other system components such as the context awareness engine 522, facilitating the secure casting of primary media windows and the generation of contextually aware secondary windows. In a preferred embodiment, it ensures that secondary windows can securely recognize and respond to the content and context presented in other displayed windows. The media casting manager 526 within the secure casting network 514 preferably manages the secure transmission of media content to one or more display devices. Integrated with third-party networks 134, such as media services 536a, the manager 526 facilitates the casting of media content not only from internal sources but also from external content libraries like content library 536. For instance, in a dual-screen movie or tv-watching scenario, the primary screen displays the main content while the secondary screen augments the user experience by displaying additional, contextually relevant information. The media casting manager preferably coordinates with the multi-window manager 524 to synchronize these primary and secondary data windows in real-time. For instance, if a user skips to a different scene in a movie on the primary screen, the secondary screen updates simultaneously to display contextually relevant content. The media casting manager 526 furthermore interfaces with the security manager 520 to ensure that all transmitted data, whether sourced internally or from third-party networks 134, is secure and compliant with the multi-layer authentication process.

The synchronization controller 528 within the secure casting network 514 is preferably responsible for real-time coordination between primary and secondary data windows across single or multiple display devices. Through programmatic interfaces, it preferably manages temporal and contextual synchronization between various windows to create a unified user experience. For instance, in a dual-screen movie or tv-watching scenario, this controller ensures that user activities like skipping scenes on the primary screen are seamlessly mirrored on the secondary screen, which simultaneously updates to display contextually relevant information. In a smart home system control use case, the controller allows for the real-time adjustment of settings like temperature or lighting through a secondary screen, reflecting those changes instantaneously on a primary wall-mounted display. The synchronization controller 528 works in concert with other system components, such as the multi-window manager 524 and security manager 520, to achieve secure and synchronized operations across the multi-window display environment comprising one or more displays 316 or appliances 504.

In a preferred embodiment, to ensure that updates occur in real-time, the synchronization controller 528 incorporates a real-time event loop that perpetually checks for changes or interactions within the secondary window. Upon identifying an event, the stored frames, timestamps, time vector, and source address are harnessed to synchronize the primary and secondary screens with high fidelity. A specialized algorithm may be used to determine the exact frame and content that should be displayed on the primary screen, based on the interactions taking place in the secondary window. This could involve straightforward linear mapping algorithms or more complex, non-linear approaches that make use of machine learning techniques to anticipate user behavior for a more dynamic synchronization experience. Furthermore, the transmission of data and commands between the primary and secondary screens may be carried out through encrypted channels, featuring hash functions and secure tokens to affirm the legitimacy of the synchronization commands.

Several real-world applications serve to illustrate these technical details. In a preferred embodiment, should a user opt to skip ahead to a different scene via the secondary screen, the synchronization controller 528 may promptly identify the corresponding frame and timestamp stored in the buffer. Utilizing this data, the primary screen is instantaneously updated to display the new scene, ensuring a coherent viewing experience. In another preferred embodiment, clicking on a product displayed on the primary screen triggers the controller to activate the relevant product page on the secondary screen. This feature is enacted by making use of time vectors and source addresses, achieving an instantaneous update with no perceptible delay to the user. These real-world examples demonstrate the system's capabilities in providing robust, efficient, and seamless temporal synchronization.

In a preferred embodiment, a user may be engaging with a multi-window display in an environment comprising one or more displays 316 or appliances 504 facilitated by the synchronization controller 528. The primary window may be streaming a YouTube video, while the secondary window may display a social media platform, such as twitter. The user may be deeply engrossed in a discussion about renewable energy solutions via the secondary window when a particular segment of the video in the primary window piques their interest. Accordingly, the user may decide that they'd like to share this specific segment via the social media platform of the secondary window. When the user begins to compose their social media statement in the secondary window, the synchronization controller 528, already monitoring both windows in real-time, may identify the user's activity in the social media platform of the secondary window and subsequently fetch the relevant data from the primary window where the YouTube video is playing. In a preferred embodiment, this data comprises a stored frame and corresponding timestamps for the segment of the video the user is currently watching. These timestamps serve as the start and stop points for the section that has captured the user's interest. Moreover, the source address, which in this case is YouTube, along with the video title, may also be recorded. The synchronization controller integrates this information to create a suggested tweet draft in the secondary window. A clickable URL, automatically appended to the social media post, may direct future viewers to the exact start and stop timestamps of the video segment that the user found intriguing. When the user posts the tweet, the controller ensures that this link is appropriately formatted, linking back to the YouTube video at the exact time range that the user wishes to highlight. Subsequent users who see the social media post and click on the URL are directed to the YouTube video, with the video automatically beginning and ending at the precise timestamps specified. This may allow followers to experience the exact segment of the video that the original user found to be of interest, providing a highly contextual and relevant social media interaction. Therefore, the synchronization controller 528 enables not just a multi-window user experience but also an enriched, synchronized interaction across different platforms and media types.

The smart home onboarding manager 530, incorporated within the secure casting network 514, serves as the gateway for integrating various smart devices into the network, including displays 316, appliances 504, and the smart home hub 416. In a preferred embodiment, upon undergoing the system's multi-layer authentication process, the smart home onboarding manager 530 facilitates the assignment of role-based permissions and connectivity settings to displays 316 for primary or secondary display functionalities. In another preferred embodiment, the smart home onboarding manager 530 coordinates with appliances 504, allowing these devices to be managed through the network's secure multi-window display interfaces. In yet another preferred embodiment, the smart home onboarding manager 30 establishes a communication link with the smart home hub 416, centralizing the control and data aggregation for all smart devices in the environment.

The user profile database 435 on the secure casting network 514 stores authenticated user information and associated permission levels for the multi-layer authentication process. Acting in concert with the security manager 520, this database is queried to verify the identity of a user attempting to interact with the system, determining whether the user has the necessary permissions for specific actions, such as casting primary or secondary windows or managing appliances. The database further stores data related to user preferences for contextually aware secondary windows, facilitating the system's capability to automatically generate secondary windows that are both relevant and authorized for each individual user. The third-party networks 134 interact with the secure casting network 514 to extend the range and capabilities of content and services available for multi-window display within the environment comprising one or more displays 316 or appliances 504. Through a secure API gateway, third-party networks 134 can provide data streams that populate both primary and secondary windows. Content library 536, for instance, may supply the media for primary windows, while media services 536a and e-commerce 536b can offer contextually aware data and interactive options for secondary windows. These interactions are subject to the multi-layer authentication process of the secure casting network 514, ensuring that data and services from third-party networks 134 are securely integrated. Advertisers 536c and health and wellness services 536d can similarly provide content for secondary windows, which are then rendered in accordance with the system's security measures and user preferences.

The content library 536 within the third-party networks 134 serves as a repository of media resources that can be securely accessed and cast to primary windows in the environment comprising one or more displays 316 or appliances 504 via the secure casting network 514. Following multi-layer authentication, including pattern recognition and permission-level verification, the content library 536 provides computer-readable signals representing media content for display. The secure casting network 514 processes these signals to populate primary windows, enabling the subsequent generation of contextually aware secondary windows based on the content retrieved from the content library 536. Media services 536a, a component of third-party networks 134, offers a selection of media streams that can be securely integrated into the secure casting network 514 for display within the environment comprising one or more displays 316 or appliances 504. Upon successful multi-layer authentication, media services 536a transmits computer-readable signals, which are interpreted by the secure casting network 514 to populate primary media windows on the display devices. These primary media windows can then serve as the basis for the generation of contextually aware secondary windows, capable of secure interaction in accordance with the user's customized multi-window display configuration.

E-commerce 536b, as a subset of third-party networks 134, is designed to securely integrate commercial functionalities into the secure casting network 514. After undergoing the system's multi-layer authentication process, authenticated users can access e-commerce 536b within contextually aware secondary windows, providing a secure platform for commercial transactions without compromising the multi-window experience. The secure casting network 514 processes computer-readable signals from e-commerce 536b to render the commercial interface within the secondary windows, allowing users to engage in transactions that are both secure and contextually relevant to other displayed content. Advertisers 536c, a component of third-party networks 134, interacts with the secure casting network 514 to facilitate a dual-screen advertising and shopping experience within the environment comprising one or more displays 316 or appliances 504. Employing the system's multi-layer authentication features, advertisers 536c can securely populate context-aware secondary windows with product information or purchasing options that align with content displayed on the primary screen. For instance, when a user views a commercial featuring shoes on the primary screen, the secondary window can immediately display the corresponding product page from an e-commerce platform, such as amazon, based on a user's interactive selection.

An additional window can also be generated to present competing products or vendors for price and feature comparison. Health and wellness services 536d, a component of third-party networks 134, interfaces with the secure casting network 514 to provide a specialized dual-screen experience that integrates smart home controls and personal health data. Utilizing the system's capabilities for multi-layer authentication and permission-level verification, health and wellness services 536d can securely populate contextually aware secondary windows with health-related information. For instance, while a primary screen displays a recipe, a secondary window on a mobile app could provide controls for a smart oven. This enables the user to adjust oven time and temperature settings directly based on the recipe displayed. Furthermore, additional windows can be initiated to display health metrics, such as daily calorie count or energy expenditure, allowing the user to make informed health-related decisions while interacting with their environment comprising one or more displays 316 or appliances 504.

In a preferred embodiment, the user interface manager 518 provides authenticated users with specialized modes of interaction across multiple data windows in an environment comprising one or more displays 316 or appliances 504. The user interface manager 518 serves as a dynamic interface between the user and various forms of content displayed on dual screens or multi-window systems. In some preferred embodiments, it leverages specialized toolbars and features that facilitate a multitude of user actions, such as data capture, selection-based interaction, and real-time engagement with both primary and secondary screens. The user interface manager 518 may further be enhanced via integration with the context awareness engine 522, offering a more tailored, contextually relevant user experience. In practical applications, this translates to empowering users with the ability to manage diverse tasks like watching movies, shopping, or controlling smart home systems without requiring them to switch between different platforms or devices.

The user interface manager 518 allows for user interaction through selection, annotation, capture, search functionalities, etc. Across multi-window displays in an environment comprising one or more displays 316 or appliances 504. In a preferred embodiment, when watching a movie on more than one screen of a display, user interface manager 518 permits the user to select specific scenes or actors and annotate or capture related information without pausing the movie on the primary screen. In another preferred embodiment, user interface manager 518 enables immediate selection of products appearing on the primary screen, activating detailed product pages on the secondary screen, and other features when a user 405 manipulates the system 400 in order to shop. In yet another preferred embodiment, the user interface manager 518 may also offer capture features, allowing the user to screenshot or save product images for later reference. These functionalities enhance the user's capacity to interact seamlessly and dynamically with the content across both primary and secondary screens.

To prevent an un-authorized user 405 from accessing other user's 405 information and/or to limit who can control the various livestreams within this detailed description, the system 400 may employ a security method. As illustrated in FIG. 14, the security method of the system 400 may comprise a plurality of permission levels 1400 that may grant users 405 access to user content 1415, 1435, 1455 within the database 115 while simultaneously denying users 405 without appropriate permission levels 1400 the ability to view user content 1415, 1435, 1455. To access the user content 1415, 1435, 1455 stored within the database 115, users 405 may be required to make a request via the user interface 411. Access to the data within the database 115 may be granted or denied by the processor 220 based on verification of a requesting user's 1405, 1425, or 1445 permission level 1400. If the requesting user's 1405, 1425, 1445 permission level 1400 is sufficient, the processor 220 may provide the requesting user 1405, 1425, 1445 access to user content 1415, 1435, 1455 stored within the database 115. Conversely, if the requesting user's 1405, 1425, 1445 permission level 1400 is insufficient, the processor 220 may deny the requesting user 1405, 1425, 1445 access to user content 1415, 1435, 1455 stored within the database 115. In a preferred embodiment, permission levels 1400 may be based on user roles 1410, 1430, 1450 and administrator roles 1470, as illustrated in FIG. 14. User roles 1410, 1430, 1450 allow requesting users 1405, 1425, 1445 to access user content 1415, 1435, 1455 that a user 405 has uploaded and/or otherwise obtained through use of the system 400. Administrator roles 1470 allow administrators 1465 to access system 400 wide data.

In a preferred embodiment, user roles 1410, 1430, 1450 may be assigned to a user 405 in a way such that a requesting user 1405, 1425, 1445 may view user profiles 435 containing user data 435A via a user interface 411. To access the data within the database 115, a user 405 may make a user 405 request via the user interface 411 to the processor 220. In an embodiment, the processor 220 may grant or deny the request based on the permission level 1400 associated with the requesting user 1405, 1425, 1445. Only users 405 having appropriate user roles 1410, 1430, 1450 or administrator roles 1470 may access the data within the user profiles 435. For instance, requesting user 1 1405 may have permission to view user 1 content 1415 and user 2 content 1435 whereas requesting user 2 1425 may only have permission to view user 2 content 1435. Alternatively, user content 1415, 1435, 1455 may be restricted in a way such that a user 405 may only view a limited amount of user content 1415, 1435, 1455. For instance, requesting user 3 1445 may be granted a permission level 1400 that only allows them to view user 2 content 1455 related to some personal information but not all personal information. In the example illustrated in FIG. 14, an administrator 1465 may bestow a new permission level 1400 on users 405 so that it may grant them greater permissions or lesser permissions. For instance, an administrator 1465 may bestow a greater permission level 1400 on other users 405 so that they may view any user content 1415, 1435, 1455. Therefore, the permission levels 1400 of the system 400 may be assigned to users 405 in various ways without departing from the inventive subject matter described herein.

FIG. 6 provides a flowchart 600 detailing certain, preferred method steps that may be used by a secure casting network 514 to interact with a set of managers. Step 605 illustrates the beginning of the method. In step 610, the secure casting network 514 is initialized to establish the primary framework for multi-window interactions within an environment comprising one or more displays 316 or appliances 504. For instance, in a dual-screen movie watching experience, the secure casting network 514 lays the groundwork for seamlessly streaming the movie content to the primary screen or window while allowing the secondary screen or window to interact with contextually relevant data. Similarly, in a home shopping context, the network initializes the pathways for sending shopping content to a primary screen while enabling instant shopping actions on a secondary screen. During step 615, the secure casting network 514 triggers a multi-layer authentication process involving security manager 520 is to validate user access. In a preferred embodiment, security manager 520 operates during this step to ensure only authorized users can access premium or age-restricted content across dual screens. For smart home management, the authentication process grants users the ability to control various smart home features securely through the primary and secondary displays.

During step 620, the secure casting network 514 initializes smart home onboarding manager 530 to guide new users through the initial setup procedures. In a preferred embodiment, the smart home onboarding manager helps the user in setting preferences for types of content and preferred secondary screen functionalities for watching movies with a dual screen experience. In another preferred embodiment, the smart home onboarding manager 530 assists in configuring payment methods and shipping details for users using the system for home shopping. During step 625, the secure casting network utilizes display controller manager 516 to manage how content is displayed across multiple screens or windows. In a preferred embodiment, display controller manager 516 controls the formatting and resolution of the movie on the primary screen and the additional content on the secondary screen during a movie-watching experience. In another preferred embodiment, display controller manager 516 regulates the display of products and pricing information of competitive products across distinct displays while shopping from home.

During step 630, the secure casting network 514 utilizes the user interface manager 518 to facilitate user interactions across the system. In a preferred embodiment, user interface manager 518 enables notetaking during a movie, adding products to the shopping cart while shopping, and other features. In a shopping context, the user interface manager 518 enables the user to easily navigate through product listings and add items to the cart using the secondary screen. During step 635, the context awareness engine 522 is engaged to make the system aware of the contextual relevance of the multiple windows. In a preferred embodiment, context awareness engine 522 identifies scenes or actors in the primary screen and provides relevant information on the secondary screen in a dual-screen movie-watching experience. In another preferred embodiment, it identifies products on display and instantly populates relevant product pages or competing offers on the secondary screen when a user is manipulating the user interface to shop. In step 640, the secure casting network 514 operates the multi-window manager 524 to control the layout and interaction between the multiple display windows. For instance, in a recipe-cooking context, one window could display the recipe, another the preparation video, and another could show the user's health data.

During step 645, control board 406 mediates interaction with third-party networks 134 to fetch or send data outside the secure casting network 514. In a preferred embodiment, a third-party service might provide reviews or actor biographies displayed on the secondary screen during a movie. In another preferred embodiment, it could fetch real-time pricing information from various vendors for price comparison while home shopping. During step 650, the secure casting network 514 initiates media casting manager 526 to manage the actual content streaming. In a preferred embodiment, media casting manager 526 controls the simultaneous streaming of the movie and the secondary content in a dual-screen setup. In another preferred embodiment, media casting manager 526 handles the streaming of the commercial or program on the primary screen while home shopping. During step 655, secure casting network 514 utilizes synchronization controller 528 to keep both primary and secondary screens in sync. In a preferred embodiment, if a user skips to a particular scene in a movie on the primary screen, synchronization controller 528 ensures any notes or contextual data on the secondary screen are also adjusted to match the new scene. In another preferred embodiment, synchronization controller 528 ensures that clicking a product on the primary screen while shopping immediately brings up the corresponding page on the secondary screen. During step 660, secure casting network 514 queries the user profile database 435 to retrieve or update user-specific data. For instance, in a dual-screen movie experience, this could involve retrieving saved preferences or notes related to previously watched movies. In a preferred embodiment, a user manipulating the system 400 to shop causes the system 400 to recall saved payment methods or previously viewed products. The method ends with terminal step 665.

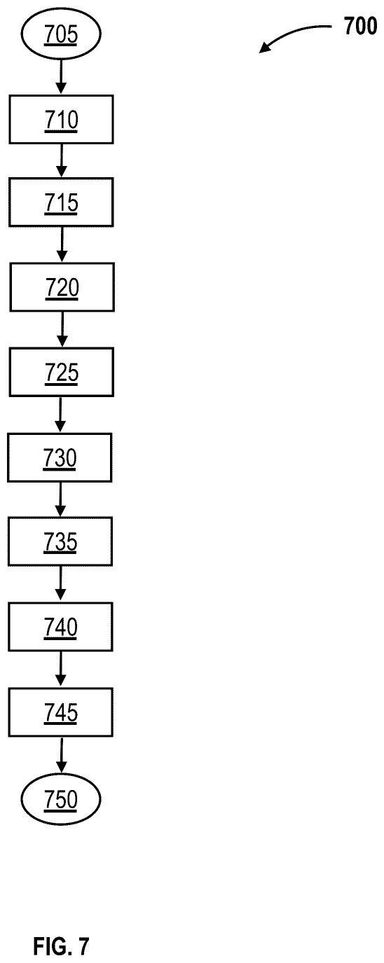

FIG. 7 provides a flow diagram 700 detailing certain, preferred method steps to affect the functioning of the display controller manager 516. Step 705 indicates the beginning of the method. In step 710, secure casting network 514 initiates display controller manager 516 to serve as a centralized orchestrator for managing multi-window displays. In a preferred embodiment, display controller manager 516 initializes the multi-screen configuration when a user wants to watch a movie while having a secondary screen for additional context. In another preferred embodiment, display controller manager 516 is initiated to manage how product listings are displayed across screens while home shopping. During step 715, user authentication is conducted through the user profile database 435 to validate that the user has the necessary permissions to interact with specific devices or services connected with system 400. Said devices may include displays 316, appliances 504, and/or third-party network 134 services such as media services 536a, e-commerce 536b, advertisers 536c, or health and wellness services 536d. In a preferred embodiment, user authentication ensures that only authorized users can access age-restricted content in content library 536 or other media services 536a. In another preferred embodiment, the authenticated user could have saved payment options during a home shopping experience that allow for seamless transactions with e-commerce 536b.

During step 720, display controller manager 516 receives display instructions from a computing device 410. In a preferred embodiment, said display instructions comprise the user selecting a film from content library 536 on third-party networks 134 and its associated audio and subtitle settings from their mobile device. In another preferred embodiment, the user indicates preferences for how product listings for home shopping should be sorted, e.g., by price or customer ratings in e-commerce 536b. In step 725, display controller manager 516 interacts with displays 316 within an environment comprising one or more displays 316. This step enables the content chosen by the user to be appropriately displayed. In a preferred embodiment, engaging display controller manager 516 while watching a movie ensures the displays 316 show the movie on one screen and additional content on another, such as closed captions, actor biographies, director commentary, etc. Similarly, while home shopping one display 316 might show a live stream of a shopping channel while the other provides product details, pricing information, reviews and ratings, etc. In yet another preferred embodiment, one or more of a subset of displays 316 may be selected while the others are left inactive.

During step 730, display controller manager 516 casts the primary media window onto the designated display device. In a preferred embodiment, a movie would be displayed as the primary window of a cinematic experience. In another preferred embodiment, the primary window displays featured products when a user is using the system for shopping. In step 735, display controller manager 516 adds one or more contextually aware secondary windows to augment the primary media window. In a preferred embodiment, watching a movie prompts display controller manager 516 to populate these secondary windows with trivia about the actors or scenes. In some preferred embodiments, a user 405 may be able to use their computing device 410 to answer said trivia and compete with other users of the system 400. In another preferred embodiment, secondary windows could display reviews or similar products while a user 405 is shopping.

During step 740, all window content and context are synchronized utilizing the synchronization controller 528. For instance, if a user skips ahead in a movie, the related trivia in the secondary window would also advance to stay relevant. In a preferred embodiment, if a user 405 is shopping and selects a different product as the focus, secondary windows update to display relevant information. During step 745, the display controller manager 516 controls and maintains the formatting and resolution of the content across multiple screens. This ensures optimal visual experience, whether the user is watching a movie in high-definition or shopping with detailed product images. The method terminates with step 750.

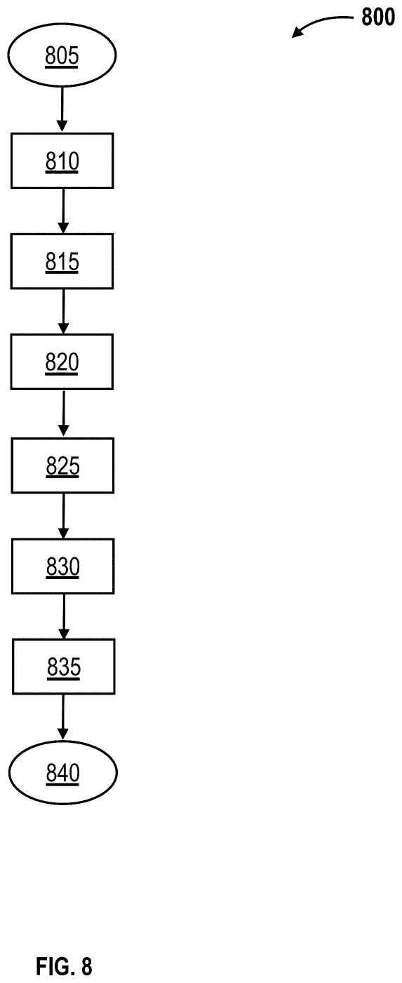

FIG. 8 provides a flow diagram 800 detailing certain, preferred method steps by which the functioning of the user interface manager 518 is affected. Step 805 indicates the beginning of the method. In step 810, secure casting network 514 initializes the user interface manager 518. During step 815, the dual-screen toolbar is enabled in the user interface manager 518, offering a range of functionalities that are activated on the secondary screen. In one preferred embodiment, the dual-screen toolbar facilitates actions like capturing QR codes and activating information panels. In another preferred embodiment, the dual-screen toolbar provides an option for looking up actor information without disturbing the primary screen displaying a movie. In yet another preferred embodiment, the dual-screen toolbar could offer a “quick add to cart” option that works in tandem with the primary screen when a user is using the system for shopping online.

During step 820, capture features are enabled within the dual-screen toolbar. In a preferred embodiment, these features allow the user 405 to capture data from the primary screen, such as QR codes or product images. In another preferred embodiment, capture features enable the viewer to capture a particular scene to later look up related trivia or behind-the-scenes information. In yet another preferred embodiment, capture features allow the user to capture the image of a product displayed in a commercial on the primary screen to quickly add it to a shopping cart on the secondary screen. In step 825, selection-based interaction from the secondary screen is enabled. In a preferred embodiment, selection-based interaction allows users to interact with specific items displayed on the primary screen by making selections on the secondary screen. In another preferred embodiment, selection-based interaction allows the user to tap on a product shown on the primary screen and immediately view its detailed page on the secondary screen. In still another preferred embodiment, selection-based interaction allows a user to highlight an actor's face to get a bio or list of other movies the actor has been in, displayed on the secondary screen. In yet another preferred embodiment, selection-based interaction may allow a user to select a portion of the primary display to perform a reverse image search, allowing the user to, for instance, identify the location of a monument shown in a movie on the primary screen.

During step 830, real-time engagement with both primary and secondary data windows is enabled. In a preferred embodiment, this feature maintains synchronization between the two screens via the synchronization controller 528. For instance, skipping to a new scene in a movie on the primary screen could bring up trivia relevant to that scene on the secondary screen. Similarly, if a user 400 clicks on a new product while shopping, the secondary screen updates to provide more details about that specific product. During step 835, multi-window interactive features are enhanced through integration with the context awareness engine 522. Context awareness engine 522 provides real-time analysis to make the user interaction more dynamic and contextually relevant. For instance, while watching a cooking show, the context awareness engine 522 could sync with smart home devices like an oven to automatically suggest the correct temperature and time for a recipe shown on screen. In a preferred embodiment, context awareness engine 522 retrieves price comparisons or reviews from multiple vendors as soon as the user shows interest in a product on the primary screen. The method terminates with step 840.

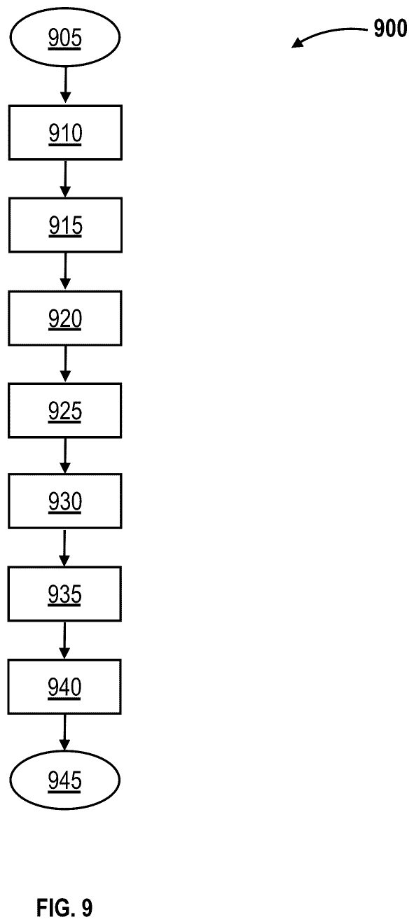

FIG. 9 provides a flow diagram 900 detailing certain, preferred method steps by which the functioning of security manager 520 is affected. Step 905 indicates the beginning of the method. In step 910, the security manager 520 is initialized within the secure casting network 514. In a preferred embodiment, step 910 lays the groundwork for secure multi-window experiences across primary and secondary screens in an environment comprising one or more displays 316 or appliances 504. For instance, in a dual-screen movie-watching experience, the security manager ensures that any additional content or notes pulled up on the secondary screen are securely transmitted and displayed. In another preferred embodiment, security manager 520 verifies the security of transactions when a user shopping online pulls up a product page or adds an item to their cart on the secondary screen. During step 915, security manager 520 executes a multi-stage authentication process. In a preferred embodiment, this process includes, but is not limited to, device id, biometrics (e.g., Fingerprint, face id, etc.), passwords, two-factor authentication, or any combination thereof. In a preferred embodiment where the primary screen controls home automation, the multi-layer authentication ensures that only authorized users can adjust settings like lighting and temperature. In another preferred embodiment, only authenticated users would be able to pull up actor biographies or other proprietary content on the secondary screen during an interactive movie-watching experience.

During step 920, pattern recognition mechanisms, such as QR code identification, are performed. In a preferred embodiment, this step aids in the validation and activation of functionalities on either the primary or secondary screens. In another preferred embodiment, a display 316 that is ready for content to be displayed could display a QR code which is then scanned by a computing device 410 using the user interface 411. By scanning the displayed QR code, the computing device 410 may then be able to cast content securely on the displays, allowing device identification and secure content display in one intuitive step. In another preferred embodiment, a QR code may be displayed with a media stream to allow the user to display additional content. For instance, a QR code could appear during a movie with additional behind-the-scenes content. The secondary screen would then recognize this pattern and allow the user to access the content without disrupting the movie. In yet another preferred embodiment, a QR code for a special discount is directed to appear next to a product on the primary screen, and the secondary screen would recognize this pattern and automatically apply the discount in the user's shopping cart.

During step 925, permission levels for the various functionalities are verified. This step confirms the authorization level of the users 405 and allows or denies access accordingly. In a preferred embodiment, in a household where children and adults are watching a movie, the system restricts access to certain types of additional content or interactive features based on user profiles. In another preferred embodiment, the system restricts the ability to finalize a purchase to users with appropriate permission levels, helping to prevent unauthorized transactions. During step 930, the security manager 520 validates the transmission of computer-readable signals intended for the primary and secondary data windows. This step ensures that the content displayed is secure and from trusted sources. In a preferred embodiment, when watching a movie, the system securely transmits actor bios or trivia to the secondary screen. In another preferred embodiment, the security manager 520 ensures that product pages or cart information displayed on the secondary screen are securely transmitted, thus safeguarding against data breaches or unauthorized modifications.

During step 935, access to primary and secondary data windows is enabled. Once the user is authenticated and the signal is validated, the data windows become accessible for content display and interaction. In a preferred embodiment, this step ensures that a trivia window on the secondary screen becomes available while watching a movie. In another preferred embodiment, the user is enabled to interact with product listings on the secondary screen when shopping, directly related to the items shown on the primary screen. During step 940, secure content and context recognition between primary and secondary windows is enabled. This step allows the two screens to interact in a secure manner while recognizing the content and context displayed on each utilizing the context awareness engine 522. For instance, in a system comprising at least one display 316 or at least one appliance containing one or more sensors, the user may coordinate a recipe shown on the primary display with a smart oven, adjusting time and temperature settings securely through the secondary screen. In another preferred embodiment, this would enable the secondary screen of the user interface to update with relevant trivia or notes when the user skips to a new scene while watching a movie on the primary screen of the user interface. The method terminates with step 945.

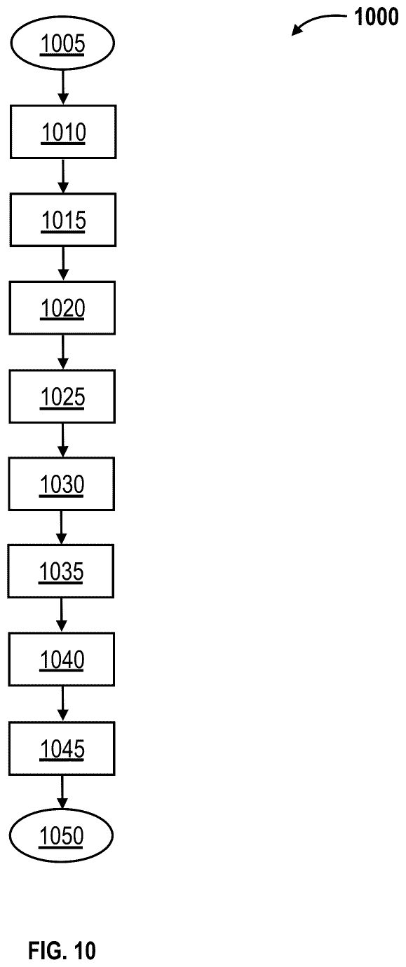

FIG. 10 provides a flow diagram 1000 detailing certain, preferred method steps by which the functioning of context awareness engine 522 is affected. Step 1005 indicates the beginning of the method. In step 1010, the context awareness engine 522 is initialized within the secure casting network 514 to facilitate the generation and management of contextually aware secondary windows. In a preferred embodiment, initialization of dual-screen movie watching allows the context awareness engine 522 to begin synchronizing additional, context-relevant content on a secondary screen without interrupting the primary movie display. In another preferred embodiment, the context awareness engine 522 enables seamless product look-up and purchasing capabilities on a secondary screen while the primary screen continues to display a shopping program or commercial. During step 1015, verification of user authentication is conducted in coordination with security manager 520. In a preferred embodiment, the verification of user authentication ensures that only authorized users can access content like age-restricted media or user-restricted smart home devices. In another preferred embodiment, verification of user authentication verifies that a user is authorized to view product pages and add items to the cart, thus preventing unauthorized transactions.

During step 1020, the context awareness engine receives instructions for dynamically generating and updating secondary data windows. In a preferred embodiment, the instructions comprise user inputs to generate a secondary window showing trivia about the current movie scene. In another preferred embodiment, when a user 405 is shopping online and clicks on a product on the primary screen, the context awareness engine receives instructions to instantly pull up that product's amazon page on the secondary screen. During step 1025, the secondary windows are tailored to respond to the content and context of the primary and other secondary windows. In a preferred embodiment, the system adjusts the type of information displayed on a secondary screen of the user interface based on the scene currently playing on the primary screen of the user interface. In another preferred embodiment, the secondary window of a shopping website adjusts to display similar or complementary products based on what a user 405 is viewing on the primary screen of the user interface.

During step 1030, synchronization of context-relevant data across primary and secondary windows is executed in conjunction with the synchronization controller 528. In a preferred embodiment, if a user skips to a specific scene in a movie on the primary screen, the notes or trivia displayed on the secondary screen automatically update to be relevant to the new scene. In another preferred embodiment, the user 405 opens a third window that synchronizes competing products or vendors, allowing real-time price and feature comparison without manual searching. During step 1035, context-aware selection is enabled, allowing for cohesive interactions between the primary and secondary screens. In a preferred embodiment while watching a movie, the user selects an actor's name from the primary screen and the secondary screen instantly displays the actor's biography. In another preferred embodiment, a user might click on a clothing item in the primary window of the user interface, and the secondary window of the user interface would display accessory recommendations based on that selection.

During step 1040, information capture features are activated. For instance, during a movie, a QR code may appear for special behind-the-scenes content. The user could activate a toolbar on the secondary screen to capture this QR code from the primary screen without requiring an external device. Similarly, the user might screenshot a wristwatch shown in a movie scene, and the system 400 could perform an image search to identify that wristwatch in a separate window. During step 1045, integration with devices linked and coordinated by control board 406 is enabled. In a preferred embodiment, the user views a recipe on a primary wall-mounted display panel in their home and uses a secondary display to adjust their smart oven settings according to the recipe's instructions. In another preferred embodiment, the primary display shows a multifaceted window, comprising a video of the recipe preparation, the user's health data, and other personalized information, all of which could be securely controlled via the secondary screen. The method terminates with step 1050.

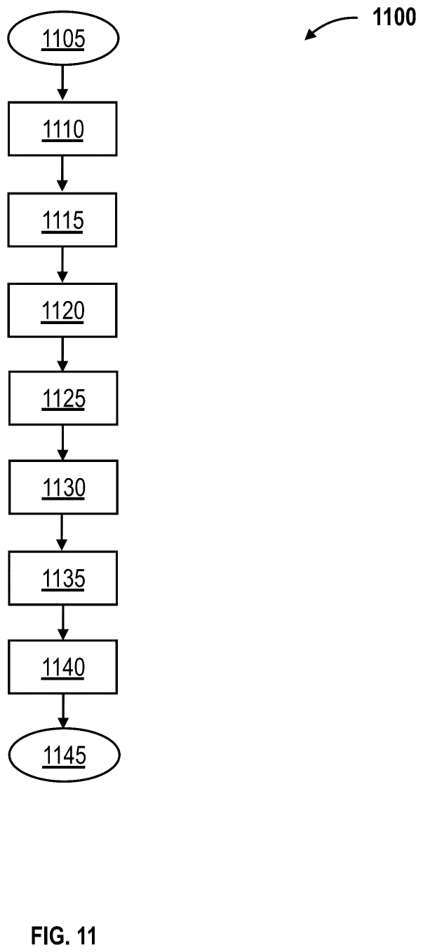

FIG. 11 provides a flow diagram 1100 detailing certain, preferred method steps by which the functioning of the multi-window manager 524 is affected. Step 1105 indicates the beginning of the method. In step 1110, multi-window manager 524 is initialized to manage primary windows and secondary windows presented on the display. In a preferred embodiment, when a user attempts to enter dual screen mode on a display of a smart home via a computing device of the user that is operably connected to the system, initialization of the multi-window manager 524 allows for the splitting of the display into more than one window. During step 1115, verification of user authentication is conducted in coordination with security manager 520. In a preferred embodiment, this step ensures that only authorized users can split the screen of a display into a primary window and at least one secondary window in the manners described herein.

During step 1120, the multi-window manager 524 receives instructions pertaining to the creation of secondary windows in addition to the primary window. In a preferred embodiment, a user may select via a user interface a number of applications that they would like presented on the display via a number of secondary display windows and/or the primary display window. In another preferred embodiment, the only instructions received from a user may pertain to what content the user would like displayed in the primary window and/or secondary window, allowing the system to manage how the content is displayed within said windows on the display. In step 1125, the multi-window manager 524 is configured to coordinate with the context awareness engine 522 to manage content displayed within the secondary windows. In a preferred embodiment, a user generates more than one secondary window for displaying information pertaining to particular scenes about a movie. Accordingly, multi-window manager 524 adds the secondary windows for displaying movie information whereas the context awareness engine 522 ensures that relevant information about a scene is presented in the windows. Furthermore, context awareness engine 522 ensures that multiples of the information are not presented in the secondary windows.

During step 1130, the multi-window manager 524 controls the placement of the primary window and secondary windows about the display. In a preferred embodiment, when a user provides the types of content they would like presented within the primary window and secondary window(s) of a display but not the location within the display, the multi-window manager 524 manages the placement of the windows about the display. In some preferred embodiments, this may be done in coordination with the context awareness engine 522 in order to ensure that the placement of the windows about the display makes contextual sense. During step 1135, the multi-window manager 524 optimizes the size of the primary window and secondary window(s) of the display. For instance, when a user is interacting with a secondary window, the secondary window may be increased in size by the multi-window manager 524 to allow for better viewing by a user. During step 1140, the multi-window manager 524 suppresses secondary window content based on what content is presented in the primary window. In a preferred embodiment, if a user was using the primary window for shopping and then switches to watching a movie, the multi-window manager 524 closes or minimizes secondary windows related to shopping. The method terminates with step 1145.

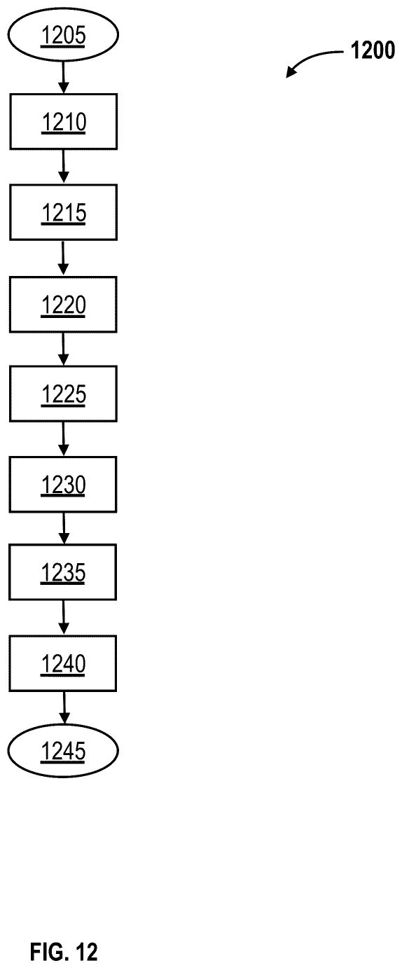

FIG. 12 provides a flow diagram 1200 detailing certain, preferred method steps by which the functioning of media casting manager 526. Step 1205 indicates the start of the method. In step 1210, the secure casting network 514 initializes the media casting manager 526, allocating resources and preparing the system for media content distribution. In a preferred embodiment, the media casting manager 526 sets up the infrastructure for dual-screen movie watching, streaming a movie on the primary screen while reserving resources for displaying actor information or user notes on a secondary screen. In another preferred embodiment, media casting manager 526 readies itself to cast a recipe video to a primary wall-mounted display panel while allowing a secondary mobile app screen to control displays, devices, and appliances comprising at least one sensor connected via control board 406. During step 1215, an interface is established with the security manager 520 to ensure that the transmission of data complies with security protocols. In a preferred embodiment, while shopping online, the security manager 520 checks for authentication before a user can pull up an amazon page for a product displayed on a tv commercial on the primary screen. In another preferred embodiment with capture features enabled, before the QR code from a donation ad on the primary screen is captured on the secondary screen, the security manager 520 may validate the secure transmission of sensitive data.

In step 1220, integration occurs with third-party networks 134, such as media services 536a, to expand the range of available content. In a preferred embodiment, a user 405 may access third-party content like trailers or interviews from media services 536a on the secondary screen during a movie played on two screens. In another preferred embodiment, integration allows the secondary screen to display product alternatives from multiple vendors when a user is watching a shopping program. During step 1225, coordination is initiated with the multi-window manager 524 to organize the primary and secondary data windows in real-time. In a preferred embodiment, when a user is shopping from home and clicks a product on the primary screen, the multi-window manager 524 ensures that the product's amazon page opens up instantly on the secondary screen.

During step 1230, the primary media content is securely cast to the designated display 316. In a preferred embodiment, this step entails the main film content is streamed to the primary screen while watching a movie. Similarly, in an environment comprising one or more displays 316 or appliances 504, a recipe video could be cast to a wall-mounted display panel in the kitchen. In step 1235, secondary media content is cast onto one or more other displays 316 to augment the user 405 experience. In a preferred embodiment, while watching a movie on the primary screen the secondary screen displays a timeline of a displayed actor's career or other films in which they have acted. In another preferred embodiment, the secondary screen might display customer reviews or similar products when the primary screen showcases a particular product.

During step 1240, real-time synchronization occurs to ensure that any changes in the primary window are reflected in the secondary window immediately. In a preferred embodiment, if a user 405 decides to skip to a particular scene while watching a movie, the notes or context on the secondary screen adjust in real-time. In another preferred embodiment where system 400 coordinates one or more devices, displays, or appliances comprising at least one sensor, a user selects a specific cooking time and temperature based on a recipe displayed on the primary screen and a smart oven adjusts its settings in real-time. The method terminates with step 1245.

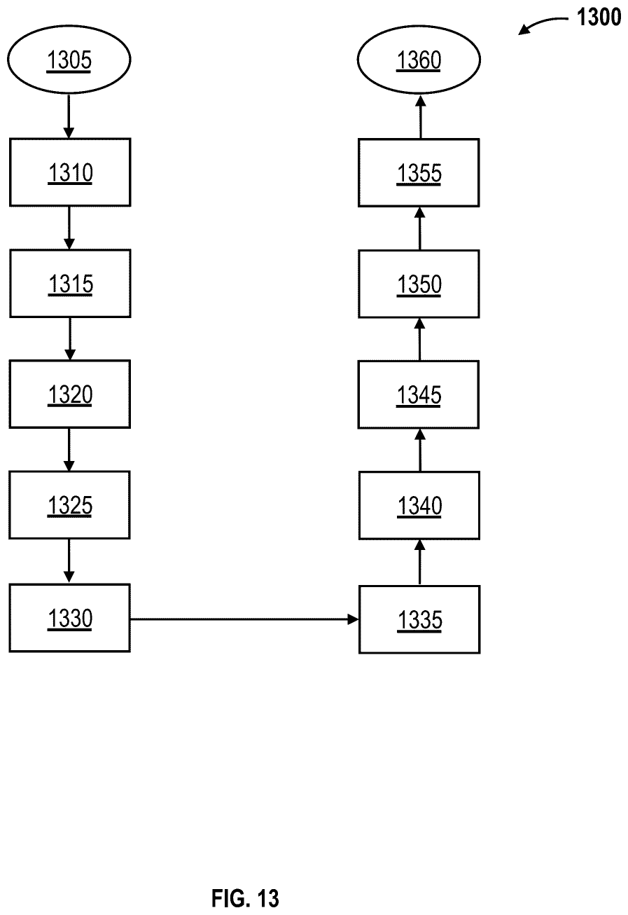

FIG. 13 provides a flow diagram 1300 detailing certain, preferred method steps by which the functioning of the synchronization controller 528 is affected. Step 1305 indicates the beginning of the method. In step 1310, the secure casting network 514 initializes the synchronization controller 528 to manage real-time coordination between primary and secondary data windows. In multiple preferred embodiments, initialization includes configuration settings and resource allocation. For instance, in a dual-screen movie-watching setup, synchronization controller 528 is initialized to ensure that user activities like skipping scenes are managed in real time across the primary and secondary screens. Similarly, in a preferred embodiment with one or more appliances comprising one or more sensors, the synchronization controller 528 is initialized to manage real-time settings such as temperature or lighting adjustments across multiple display panels. During step 1315, the synchronization controller 528 interfaces with the security manager 520 to ensure secure communication and data handling across multiple windows. In a preferred embodiment, the synchronization controller 528 interfaces with security manager 520 while playing a movie to make sure that user interactions like taking notes or pulling up actor information on the secondary screen are securely managed. In another preferred embodiment, the synchronization controller 528 interfaces with security manager 520 to ensure that transactions and product page loads are secure while shopping.

During step 1320, the synchronization controller 528 coordinates with the multi-window manager 524 to manage multiple display windows. In a preferred embodiment, said coordination involves the layout and arrangement of primary and secondary screens or windows. For instance, in a dual-screen movie-watching setup, the multi-window manager 524 may be coordinated to display main content on the primary screen while displaying supplementary, contextually relevant information on the secondary screen. In another preferred embodiment, in an environment comprising one or more displays 316 or appliances 504, coordination with the multi-window manager 524 enables the display of environmental automation controls on the secondary screen while reflecting changes on a primary wall-mounted display.

During step 1325, the synchronization controller 528 manages temporal synchronization to ensure real-time updates across multiple windows. Such synchronization involves precise timing control for activities such as scene skipping or instant data reflection. In a preferred embodiment, when a user skips to a new scene while watching a movie, temporal synchronization ensures that the contextually relevant information on the secondary screen is updated in real time. In another preferred embodiment, if a user shopping online clicks on a product appearing on the primary screen, the secondary screen instantaneously reflects the corresponding product page. In yet another preferred embodiment, a central aspect of this process involves the capture and storage of each frame of content from the primary window upon each interaction occurring in the secondary window. These captured frames are preferably held in a buffer, which is complemented by an associated set of metadata to expedite their retrieval when needed.

In a preferred embodiment, a time-stamp relative to the commencement of the media content is also maintained alongside each stored frame. This time-stamping feature ensures precise synchronization for various activities, such as scene skipping or pausing media. In another preferred embodiment, the synchronization controller 528 also maintains a separate time vector, capturing the duration for which each segment of the content is viewed. The advantage of this feature lies in its ability to support more advanced synchronization algorithms, such as weighted averaging methods that contribute to smoother transitions during operations like fast-forwarding or rewinding. In addition to frame data and timing metrics, the controller may store the address of the media source, such as Netflix or YouTube, along with the title of the content. This information may serve as a common reference point that aids in achieving contextual synchronization by associatively linking the primary and secondary windows.

During step 1330, the synchronization controller 528 manages contextual synchronization, updating secondary windows with data relevant to the activity occurring on the primary screen. For instance, while watching a movie, if the primary screen displays an action sequence, the secondary screen could update to show relevant trivia or notes. In a preferred embodiment, if a user adjusts the temperature via a secondary screen, the primary wall-mounted display updates to reflect the new temperature setting. In another preferred embodiment, the synchronization controller 528 is responsible for contextual synchronization across multiple windows within an environment comprising one or more displays 316 or appliances 504. This may involve a series of actions to ensure the secondary windows display information that is contextually relevant to the primary screen. To achieve this, the synchronization controller 528 may retrieve the current context from both the primary and secondary windows. Parameters such as the type of activity, time of day, and user preferences are preferably collected. Additionally, it may access a stored context matrix from the user profile database 435, which contains a set of predicted contexts based on historical user interactions with both primary and secondary windows.

Upon retrieving the current and historical contexts, the synchronization controller 528 calculates a predicted context, leveraging machine learning algorithms that consider various variables including the type of activity on the primary screen, current settings in the secondary screen, time of day, and user preferences stored in the user profile database 435. Based on this predicted context, a multi-window configuration mode may be displayed, enabling the user to see a preview of how the secondary window would look like given the current activity on the primary window. For instance, if a user is using the primary screen as a wall-mounted display to monitor energy consumption and the secondary screen to control lighting, the synchronization controller 528 may gather these contextual elements. If the user generally prefers dim lighting at a certain time of day based on historical data, the predicted context may suggest a dim lighting setting. A multi-window configuration preview may then display this suggestion on the secondary screen, allowing the user to either confirm this setting, causing the primary wall-mounted display to update and reflect this new setting, or adjust it according to their current preference. By taking into account both current and historical context, the synchronization controller 528 may provide a more intuitive, relevant, and seamless multi-window experience for the user. It ensures that all displayed information and control options across both primary and secondary windows are pertinent to the user's current activity and preferences, thereby offering a highly personalized and efficient smart home management interface.

During step 1335, updates are made to the primary screen based on user activities or system changes. In a preferred embodiment, the primary screen would update to a new scene when a user decides to skip ahead while watching a movie. Similarly, in an environment comprising one or more displays 316 or appliances 504, if a user makes adjustments to lighting conditions through a secondary screen, the primary screen updates to reflect these changes. During step 1340, corresponding updates are made to the secondary screen. For instance, if a user skips to a scene in a movie, the secondary screen might update to display information relevant to the new scene. In a preferred embodiment, if a user shopping online clicks on a product on the primary screen, the secondary screen updates to display the product's details, specifications, or shopping cart options.

During step 1345, the synchronization controller 528 collaborates with the security manager 520 to secure multi-window synchronization, ensuring that data exchange and user interactions across primary and secondary screens or windows are conducted in a secure manner. In a preferred embodiment, this step involves encryption, tokenization, and other secure communication protocols to safeguard data integrity and user privacy. For instance, secure multi-window synchronization ensures that activities like notetaking or pulling up actor information on the secondary screen are executed securely, without exposing sensitive data or user preferences. When the user decides to skip ahead to a different scene on the primary screen, the secondary screen updates to display new, contextually relevant information, all while ensuring that these changes are securely synchronized. In a preferred embodiment, when a user uses a secondary screen to adjust settings such as temperature or lighting, collaboration with the security manager 520 ensures that these adjustments are securely transmitted and reflected on the primary wall-mounted display, ensuring that unauthorized access or malicious interference is minimized, thereby maintaining the integrity of the smart home system.

During step 1350, the synchronization controller 528 reflects changes made on the primary screen, updating its status and ensuring that all connected devices are synchronized. In a preferred embodiment, in an environment comprising one or more displays 316 or appliances 504, if the primary wall-mounted display shows a temperature setting change, this change is reflected across all linked devices, like a mobile app acting as a secondary screen. Similarly, if a user watching a movie on more than one screen skips a scene on the primary screen, this change is reflected and coordinated across all connected secondary screens. During step 1355, changes are reflected on the secondary screen to synchronize it with the primary screen. In a preferred embodiment, if a user captures a QR code on the primary screen using a toolbar on the secondary screen, this action and its results are reflected on all secondary screens. In another preferred embodiment, if a user skips scenes while watching a movie on more than one screen, the secondary screen updates to reflect this, showing information relevant to the new scene. The method terminates with step 1360.

The subject matter described herein may be embodied in systems, apparatuses, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

What is claimed is:

1. A system for securely casting customized content within an environment, comprising:
a display mechanism for rendering a plurality of windows, said display mechanism being configurable as either a single display or multiple displays;
a synchronization controller configured to manage temporal and contextual synchronization between the plurality of windows;
a security manager for providing secure data transmission and authentication between the plurality of windows;
a user profile database storing user preferences and context matrices;
wherein the synchronization controller is configured to:
a) retrieve a current context from the plurality of windows, the current context including but not limited to parameters such as type of activity, time of day, and current user settings;
b) access a predicted context from the user profile database, the predicted context being based on the current context and historical user interactions;
c) display a multi-window configuration based on the predicted context;
d) perform secure data transmission and authentication to synchronize the plurality of windows in at least one of the domains of temporal synchronization and context synchronization.
